(19) United States
(12) Patent Application Publication
(10) Pub. No.: US 2008/0307114 A1
(43) Pub. Date: Dec. 11, 2008

(54) NETWORK ASSIGNMENT METHOD AND APPARATUS

(75) Inventors: Hiroyoshi OOSHIMA, Yokohama-shi (JP); Kazuhiko MORIMURA, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/056,419

(22) Filed: Mar. 27, 2008

(30) Foreign Application Priority Data
Mar. 30, 2007 (JP) 2007-092133
Nov. 8, 2007 (JP) 2007-291239

(51) Int. Cl. G06F 15/16

(52) U.S. Cl. 709/250

(57) ABSTRACT

A network assignment apparatus receives a request of a client via the first network. The network assignment apparatus selects the second network to be assigned to the client, and assigns the second network to the client, in correspondence with one of a plurality of servers from which the client obtains contents.

### BACKGROUND OF THE INVENTION

1. Field of the Invention

The present invention relates to a network assignment method and apparatus.

2. Description of the Related Art

Conventionally, in a network system constituted by a client and a server which manages a network, when the client is connected to a network, connection information can be set by using two connection settings, i.e., a static connection setting and a dynamic connection setting.

In the static connection setting, the client holds network connection setting information in advance. The client performs the connection setting on the basis of the held information, when connecting to the network upon power-on or activation of a network I/F. In this method, since the connection setting information is held in advance, a client user needs to ask a network manager for information to be set, and set it in a client apparatus. It therefore imposes a burden on the user upon initial setting or change of a network configuration.

To the contrary, the dynamic connection setting is represented by DHCP (Dynamic Host Configuration Protocol). In this technique, when connecting to a network, a client obtains connection setting information from a network management server through a predetermined protocol, and executes a connection setting on the basis of the information. In this method, it is unnecessary for a client user to set any data in advance. It is therefore possible to readily connect especially upon an initial setting or even when the client user has a poor knowledge of networks.

The above-mentioned settings of connection to the network are premised on that there is one network to which the client connects (or can connect). That is, a technique for deciding a network to connect when there are a plurality of networks connectable by the client is not defined.

In recent years, wireless LAN networks which wirelessly connect to an access point by a radio wave have rapidly prevailed. In these wireless LAN networks, when a client apparatus is installed, a network to connect is not decided. This is because the client apparatus can connect to any access point existing around it as far as a radio wave can reach it, and the number of access points around the client apparatus can increase after the client apparatus is installed.

In wired LAN networks, there exist configurations in which a client apparatus can connect to a plurality of networks. This is a case, for example, in which a network switch (e.g., L2SW (layer 2 switch)) installed between a client apparatus and a server has a function of determining a network to which packets to be sent belong, and sending the packets only to the determined network. In this case, the client apparatus can belong to a plurality of networks without changing the physical connection form. Conventionally, when there exist a plurality of networks connectable as described above, a client apparatus selects a network as a connection destination and establishes connection upon start of the client apparatus or activation of a network I/F. After the connection is established, when it is necessary to change connection information, client- or server-initiated exchange of the connection information is executed and the connection information is thus reset.

Note that a technique for establishing connection on the basis of network connection information obtained by using a temporary address upon new connection is also known (e.g., see Japanese Patent Laid-Open No. 3-267835).

Conventionally, while a client is obtaining contents requiring a wide band, a group of clients connecting to the same network can suffer from the network load, and cannot communicate satisfactorily.

Various kinds of problems arise in obtaining contents. For example, the confidentiality of contents to be obtained cannot be ensured at the security level of a currently connected network.

There is also a technique for providing a file sharing service on a network to a plurality of clients located in the network such as a LAN or WAN. For example, iSCSI in which IP protocol is used for access on a file block basis, and a NAS (Network Attached Storage) which provides a file sharing service as a single device are known. These techniques have been widely used not only as a technique for providing a file sharing service but also as a network distribution system for, e.g., distribution of video contents, because they can provide information to devices on a network.

In the above network distribution system in the prior art, a storage device distributes the load in response to requests for access on a block basis or a file basis. However, the system does not consider providing a stationary band to distribute information such as streaming videos and audio data which are increasingly used nowadays.

Consider a case in which a client not having a sufficient memory is to access a streaming file for several hours as in on-demand video distribution. In this case, it is necessary to allocate a band in which contents can be provided while a server or a network provides individual clients with the contents.

In the conventional network distribution system, the following problems arise. That is, the system does not know how much the load variations of the server or network influence resource allocation since the system does not manage the content distribution time. Furthermore, since the file size of video contents is generally big, if a client accesses on a file basis, traffic will be temporarily heavy and server and network resources will be consumed.

U.S. Pat. No. 6,445,679 proposes a technique for transmitting or discarding data blocks by a switch node of data, and adjusting the transfer data amount so as to achieve a specified transmission rate, even if the load of a network or system varies.

However, the technique proposed in U.S. Pat. No. 6,445,679 causes quality deterioration of data to be transferred since it adjusts the transfer data amount so as to achieve a specified transmission rate by discarding data blocks when the load of a network or the like increases.

### SUMMARY OF THE INVENTION

The present invention enables realization of a network assignment method and apparatus for properly managing content distribution from a plurality of servers.

An aspect of the present invention provides a network assignment method comprising the steps of: receiving a request of a client via a first network; selecting a second network to be assigned to the client in correspondence with one of a plurality of servers from which the client obtains contents; and assigning the second network to the client.

An another aspect of the present invention provides a network assignment apparatus comprising: a reception unit adapted to receive a request of a client via a first network; a selection unit adapted to select a second network to be assigned to the client in correspondence with one of a plurality of servers from which the client obtains contents; and a assignment unit adapted to assign the second network to the client.

A still another aspect of the present invention a computer-readable storage medium storing a computer program for assigning a networks the computer program comprising the steps of: receiving a request of a client via a first network; selecting a second network to be assigned to the client in correspondence with one of a plurality of servers from which the client obtains contents; and assigning the second network to the client.

Further features of the present invention will become apparent from the following description of exemplary embodiments with reference to the attached drawings.

### BRIEF DESCRIPTION OF THE DRAWINGS

FIG. 1 is a view showing the configuration of a network distribution system according to embodiments of the present invention;

FIG. 2A is a view for explaining assignment of IP addresses in consideration of the configuration of a network distribution system;

FIG. 2B is a view for explaining assignment of IP addresses in consideration of the configuration of a network distribution system;

FIG. 2C is a view for explaining assignment of IP addresses in consideration of the configuration of a network distribution system;

FIG. 3 is a sequence chart showing data transmission/reception by DHCP between a client apparatus and a management server;

FIG. 4 is a graph showing an example of a content distribution condition;

FIG. 5 is a flowchart showing processing of deciding, by a management server, a content server as a source and a transmission path of contents; and

FIG. 6 is a view showing the configuration of a network distribution system according to the third embodiment of the present invention.

### DESCRIPTION OF THE EMBODIMENTS

Preferred embodiments of the present invention will now be descried in detail with reference to the drawings. It should be noted that the relative arrangement of the components, the numerical expressions and numerical values set forth in these embodiments do not limit the scope of the present invention unless it is specifically stated otherwise.

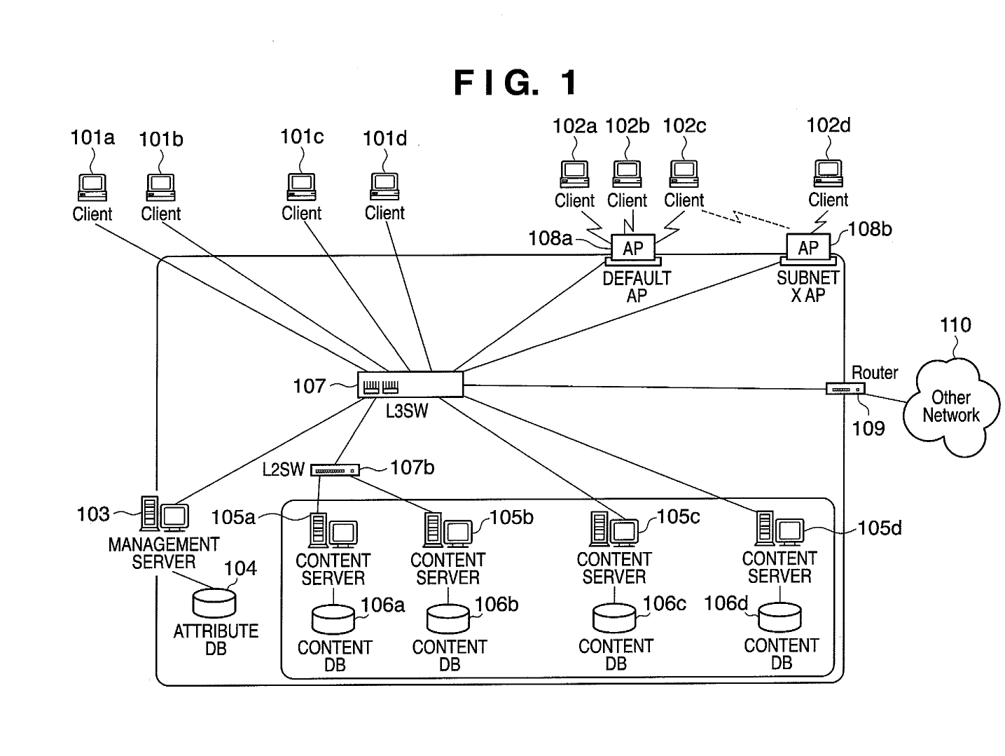

FIG. 1 is a view showing the configuration of a network distribution system according to the first embodiment of the present invention. Referring to FIG. 1, reference numerals 101a to 101d denote client apparatuses which obtain and use contents (data) such as video data, audio data, and text data; and 102a to 102d, wireless client apparatuses, similar to the client apparatuses 101a to 101d, each having a wireless network interface. Each of the client apparatuses 101a to 101d and 102a to 102d comprises a computer. Reference numeral 103 denotes a management server which manages the attributes of the contents and the like, and connects the client apparatuses 101a to 101d and 102a to 102d, and content servers 105a to 105d to a network. That is, the management server 103 manages data communication processing.

Reference numeral 104 denotes an attribute database which is connected to the management server 103 and stores information associated with a process of obtaining the contents. The information includes the attributes of the contents and those of the client apparatuses 101a to 101d and 102a to 102d. The content servers 105a to 105d send the contents. Reference numerals 106a to 106d denote content databases which are connected to the content servers 105a to 105d respectively and store the contents.

Reference numeral 107 denotes a network switch which connects the network devices to each other, such as the client apparatuses 101a to 101d and 102a to 102d, and the content servers 105a to 105d; 107b, a network switch which connects the content servers 105a and 105b to the network switch 107; 108a and 108b, access points for wireless network connection from the wireless client apparatuses 102a to 102d; 109, a network connection device (router) for connection to an external network; and 110, an external network.

The operations of the devices in response to content requests from the client apparatuses 101a to 101d and 102a to 102d in the network distribution system constituted by the above devices will now be explained step by step.

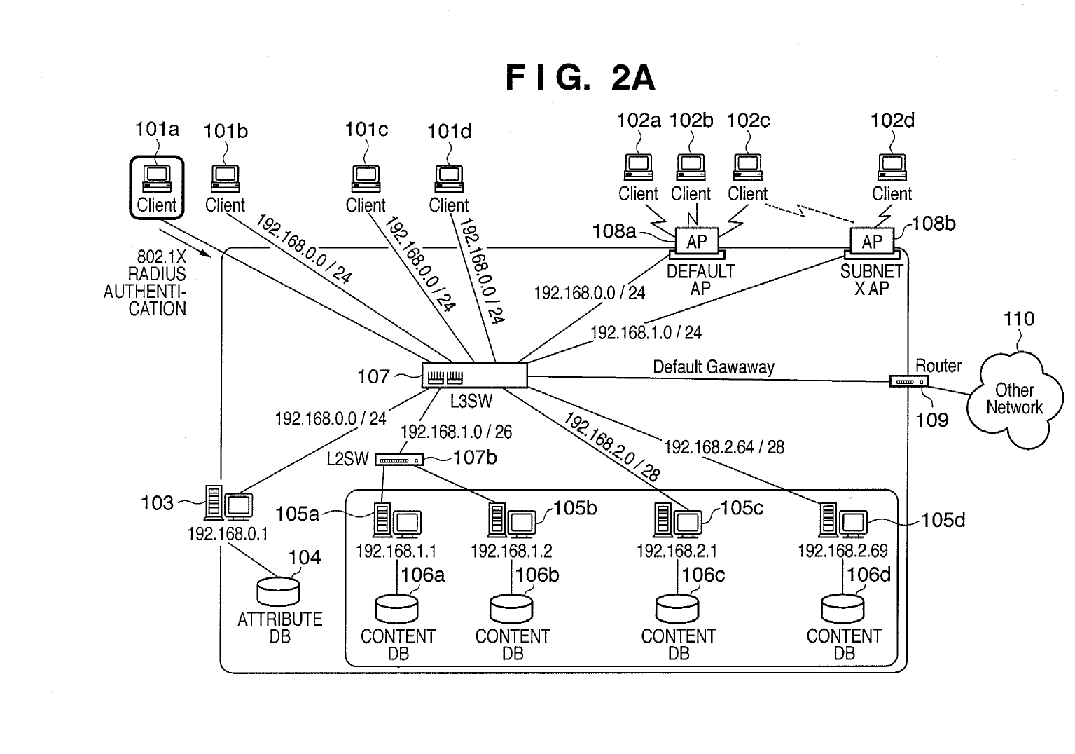

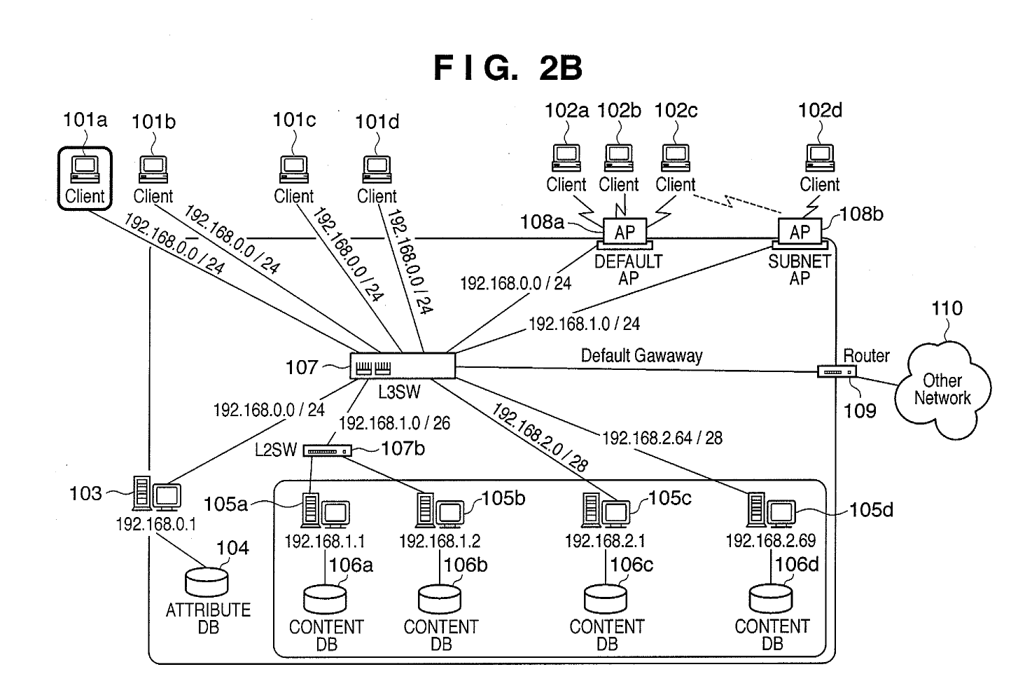

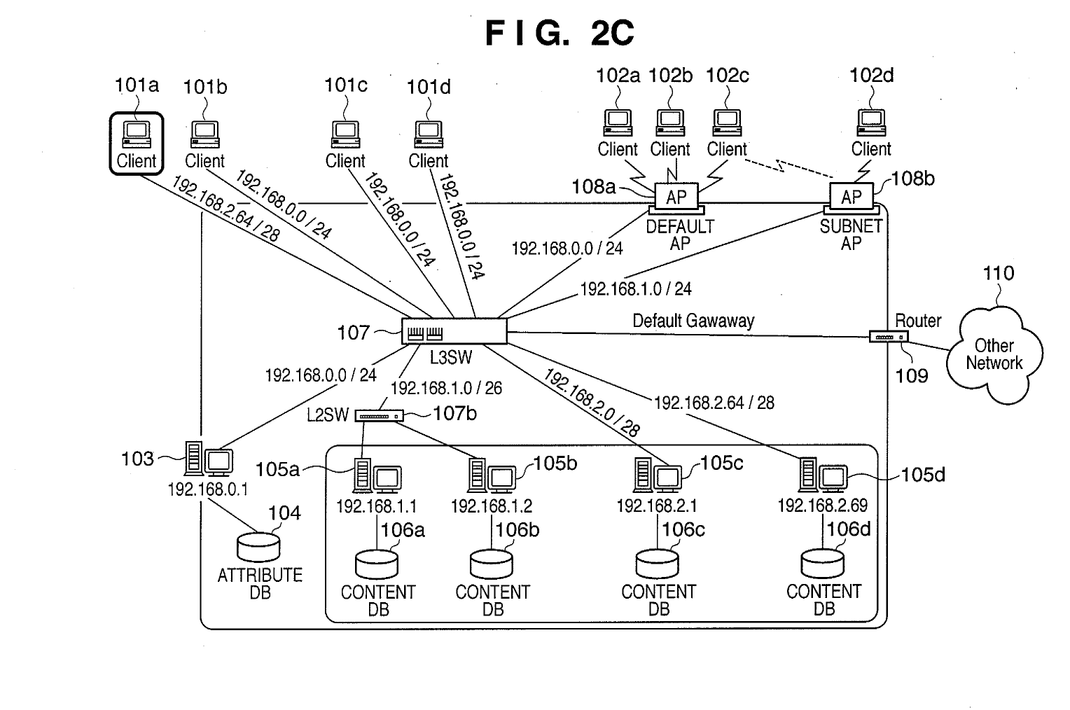

The initial state of the networks and devices which constitute the network distribution system will be described first. FIG. 2A shows IP addresses of the management server 103, content servers 105a to 105d, and sub-networks in the initial state. For example, a network to which the management server 103 is connected is assigned an IP address 192.168.0.0/24, and the management server 103 is assigned an IP address 192.168.0.1. Note that the IP address 192.168.0.0/24 is a network address assigned to the network to which the management server 103 is connected. The IP address 192.168.0.1 is a host address assigned to the management server 103.

The management server 103 has a function as a DHCP server which gives information needed when the client apparatuses 101a to 101d and 102a to 102d connect to the network, and a function of managing the contents stored in the content servers 105a to 105d.

The content servers 105a to 105d are assigned different sub-networks. However, it is also possible to assign a single sub-network to a plurality of content servers 105a and 105b by using the network switch 107b such as L3SW (layer 3 switch).

As the wireless access points, the default access point 108a used when the client apparatuses 102a and 102b in the initial state connect to the network, and the sub-network access point 108b assigned to a sub-network are prepared.

The client apparatus 101a is not assigned an IP address in the initial state (the client apparatus 101a is assigned 0.0.0.0). The network switch 107 limits access between the client apparatus 101a and the content servers 105a to 105d. They, therefore, cannot transmit/receive packets to/from each other.

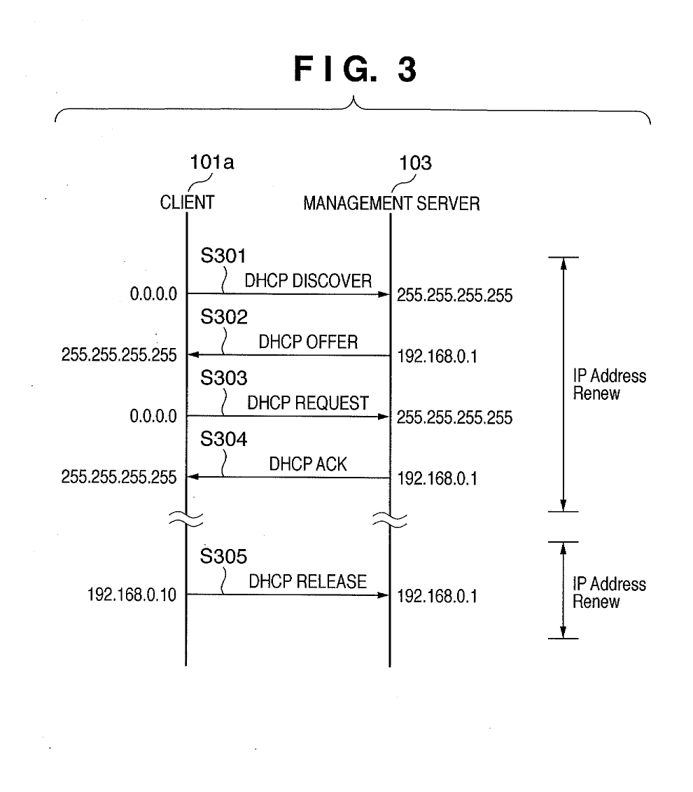

A case in which the client apparatus 101a sends a connection request to the management server 103 in order to participate in the network will be explained using FIG. 3. FIG. 3 is a sequence chart showing data transmission/reception by DHCP between the client apparatus 101a and the management server 103.

The client apparatus 101a requests the management server 103 to authenticate the client apparatus 101a itself in order to participate in the network. If, as a result of the authentication by the management server 103, the client apparatus 101a is not authenticated, it is possible to disable, by using IEEE802.1X, the sub-network itself to which the client apparatus 101a is connected.

If authenticated, the client apparatus 101a broadcasts an IP address assignment request (DHCP DISCOVERY) to the management server 103 on the network to obtain an IP address (step S301).

In response to this, the management server 103 issues an IP address offer (DHCP OFFER) (step S302). The offer contains an IP address and subnet mask. The subnet mask is information for dividing the IP address into a network address and host address.

If the offered IP address has no problem, the client apparatus 101a outputs an IP address request (DHCP REQUEST) to the management server 103 (step S303).

When the management server 103 eventually authorizes the request of the client apparatus 101a (DHCP ACKNOWLEDGE) (step S304), the IP address is assigned to the client apparatus 101a. “0.0.0.0” is used as the IP address of the client apparatus 101a until the request of the client apparatus 101a is authorized.

In the first embodiment, the client apparatus 101a need connect to the same network as that of the management server 103. As shown in FIG. 2B, a network which is connected to the client apparatus 101a is assigned a network address “192.168.0.0/24” indicating that the network belongs to the same sub-network as that of the management server 103. The client apparatus 101a is assigned “192.168.0.10” as a host address. According to the sequence of DHCP shown in FIG. 3, the client apparatus 101a can obtain an IP address belonging to the same sub-network as that of the management server 103.

A case in which the client apparatus 101a requests contents to the management server 103 will be described next. When the client apparatus 101a requests contents, the management server 103 accepts the request, and reads and obtains, from the attribute database 104, information associated with a process of obtaining the contents.

The information associated with the content obtaining process includes attribute information on the contents themselves, that on the client apparatus 101a, that on the network, and that on the content server.

The attribute information on the contents themselves includes, e.g., the data size of the contents, the confidential level of the contents, the transmission time of the contents, a band required to transmit the contents, and a content server storing the contents.

The attribute information on the client apparatus 101a includes, e.g., a transmission delay of the contents to the client apparatus 101a, the display resolution of a display (display device) of the client apparatus 101a, and a frame rate for displaying the contents.

The attribute information on the network includes, e.g., transmission performance in a transmission path of the network to which the content server belongs, the maximum band of the transmission path, and the current use condition.

The attribute information on the content server includes, e.g., content distribution performance of the content server.

Although some types of attribute information are described, all the information need not be included in the present invention. Any one piece of the attribute information mentioned above may be included as the information associated with the content obtaining process.

The management server 103 then decides a transmission path between the client apparatus 101a and the content server, which is suitable for obtaining the contents on the basis of the obtained information. The management server 103 selects, for example, a network in which a wide band can be allocated if the contents require a wide band, or an encrypted network if the confidential level of the contents is high.

With the above operation, when the management server 103 decides a transmission path between the client apparatus 101a and the content server, the client apparatus 101a leaves the currently connected network and the management server 103 controls connection by the decided transmission path. This operation will be explained using the sequence chart in FIG. 3.

First, the management server 103 requests the client apparatus 101a to leave the network to which the client apparatus 101a currently belongs, and to send a connection request again. The client apparatus 101a which has received the request issues DHCP RELEASE (step S305). By issuing DHCP RELEASE, the client apparatus 101a is temporarily disconnected from the network to which the management server 103 and the like connect.

The client apparatus 101a issues an IP address assignment request (DHCP DISCOVER) immediately after DHCP RELEASE, and requests a new IP address to the management server 103 by broadcast.

The management server 103 which has received DHCP DISCOVER recognizes through a MAC address of the client apparatus 101a that the client apparatus 101a, which had issued DHCP RELEASE, issued DHCP DISCOVER in response to the request from the management server 103. The management server 103 sends as DHCP OFFER an IP address belonging to the sub-network of the transmission path decided as described above (step S302). The client apparatus 101a issues DHCP REQUEST (step S303) if it accepts the offered IP address. The management server 103 then issues DHCP ACKNOWLEDGE (step S304). In this way, the client apparatus 101a is assigned the same sub-network as that of the content server.

FIG. 2C is a view showing a sate in which the management server 103 decides a transmission path between the client apparatus 101a and the content server 105d. As shown in FIG. 2C, the network which is connected to the client apparatus 101a is assigned, as a network address, e.g., “192.168.2.64/28” indicating that the network belongs to the same sub-network as that of the content server 105d. The client apparatus 101a is assigned “192.168.2.79” as a host address.

As explained above, in the first embodiment, when a client apparatus sends a request to obtain contents requiring a wide band, the management server 103 connects the client apparatus as the request source to a network having a small number of client apparatuses or a network having a wide communication band. This makes it possible to reduce the influence of the network load on other clients connected to the network.

In the first embodiment, by specifying a proper network on the basis of information such as the characteristics of the contents requested to be obtained, and conditions or abilities of other connectable networks, it is expected to produce various effects. For example, the speed and efficiency of the content obtaining process increase, and the security improves.

Note that when the wireless client apparatuses 102a to 102d are connected, they are grouped according to SSIDs (Service Set IDentifier) of access points to which they connect. That is, the wireless client apparatuses participate in a default network using an SSID in the initial connection, and obtain, from the management server 103, an SSID of an access point which connects to a network having the same sub-network as that of the content server similarly to the wired connection. The wireless client apparatuses leave the default network, connect to the network using the new SSID, and are provided with contents from the content server.

According to the first embodiment, it is possible to provide a system in which when a client apparatus requests contents, the management server 103 can select a proper transmission path between the client apparatus and a content server on the basis of information associated with a content obtaining process.

The second embodiment of the present invention will now be described. The configuration of a network distribution system according to the second embodiment of the present invention is the same as that in FIG. 1.

The operation in the network distribution system constituted as shown in FIG. 1 in response to content requests from client apparatuses 101a to 101d and 102a to 102d will be explained.

In the second embodiment, as shown in FIG. 2B, assume that the client apparatus 102a is assigned “192.168.0.0/24” which is the same sub-network as that of a management server 103, and is assigned an IP address belonging to the same sub-network as that of the management server 103.

The client apparatus 102a requests contents to the management server 103. At the same time, the client apparatus 102a notifies the management server 103 of its function as client attributes (client properties). Typical examples of the client attributes are a display resolution and frame rate of the client apparatus 102a. The client attributes may be read from an attribute database 104.

The management server 103 reads content attributes (content properties) corresponding to the requested contents from the attribute database 104. Typical examples of the content attributes are information such as a transmission time of the requested contents, a required band, and a resolution of the contents, and designation information of a content server 105(a-d) storing the contents. The management server 103 decides a resolution, frame rate, scheduled send time, encoding scheme, and transmission band for the contents which the content server 105(a-d) sends to the client apparatus 102a by using the content attributes and the client attributes.

Examples of the client attributes and content attributes used to determine if the contents are sent are described.

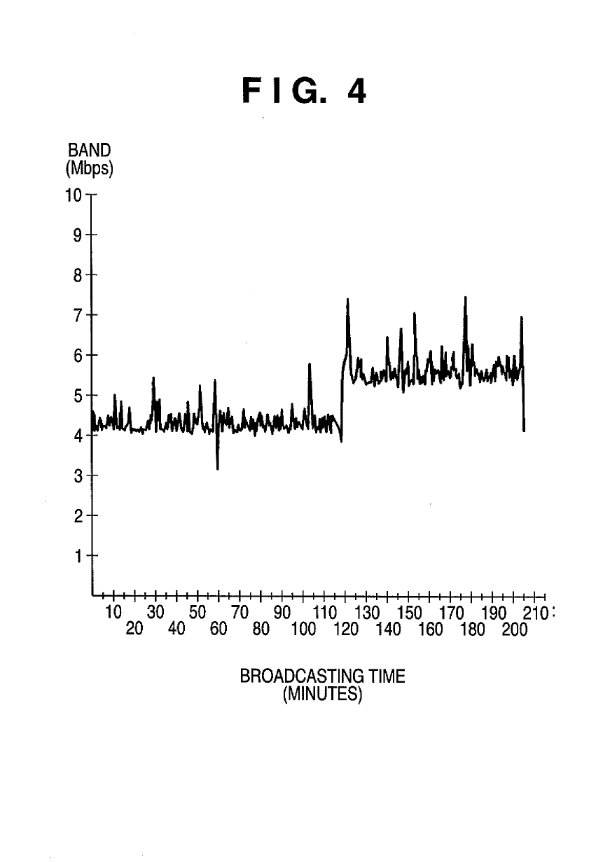

The content attributes include information indicating a broadcasting time, the resolution of an image, an encoding type, and a content server storing the contents. The content attributes also include information such as a band (Bit Rate) for the broadcasting time. If the data is not video data produced in real time but a storage type of video data, it is possible to create, as one of the content attributes in advance, a graph showing the band for the broadcasting time in FIG. 4.

The management server 103 can use the content attributes as information for predicting how network resources are scheduled to be consumed.

The client attributes include information such as a resolution of the client apparatus 102a and a processable frame rate to indicate an information amount needed by the client apparatus 102a. With these pieces of information, it is possible to prevent an excessive amount of information from being sent.

Server attributes and transmission path attributes are used for managing resources and distributing the load on the content transmission source side. The server attributes include information such as a communication load, CPU load and memory load.

The transmission path attributes include information such as the band and error rate of the transmission path and delay information.

The transmission path attributes (transmission path properties) are specified by deciding a transmission path from the client apparatus 102a to the content server 105 (a transmission path between the content server 105(a-d) and a network switch 107). It is desirable to measure the transmission path attributes regularly during the transmission of the contents since the transmission path attributes can dynamically change. When the network switch 107 cannot obtain the transmission path information due to a failure or incompatibility, it is possible to directly measure the transmission path attributes by using dummy data between the client apparatus 102a and the content server 105(a-d).

The management server 103 calculates a band required to transmit the contents by comparing the obtained transmission path attributes, content attributes, and client attributes. For example, the management server 103 determines if it decreases the resolution or the frame rate in the case of videos, or if it selects a high-efficiency encoding scheme, and then decides a transmission band, when the client apparatus 102a requests a narrow band compared to the transmission band of the contents. Furthermore, the management server 103 determines based on the server attributes of the corresponding content server and the transmission path attributes whether it is possible to allocate resources necessary for the transmission in the decided transmission band. If the transmission is possible, it is also possible to allocate the resources during the distribution time obtained from the content attributes.

FIG. 4 shows a content distribution condition in which the average band is 4.2 Mbps until 120 minutes have elapsed from the start of the content distribution, but after that, the band suddenly rises to 6.0 Mbps. It is necessary to allocate the resources through the content distribution time so as not to deplete the transmission resources during the distribution even in the case of such content distribution.

On the other hand, if it is determined that the transmission is impossible, the management server 103 determines based on the content attributes whether it can select an alternative content server. If the management server 103 cannot select an alternative content server, the management server 103 notifies the client apparatus 102a that the contents cannot be sent. Alternatively, when the management server 103 cannot allocate the resources of network, a CPU or memory of content server, the management server 103 can notify the client apparatus 102a that the contents cannot be sent, with reference to the server attributes of the corresponding content server. In this manner, by restricting the transmission of new contents, the management server 103 ensures that the contents are sent to the client apparatus 102a which has already been connected.

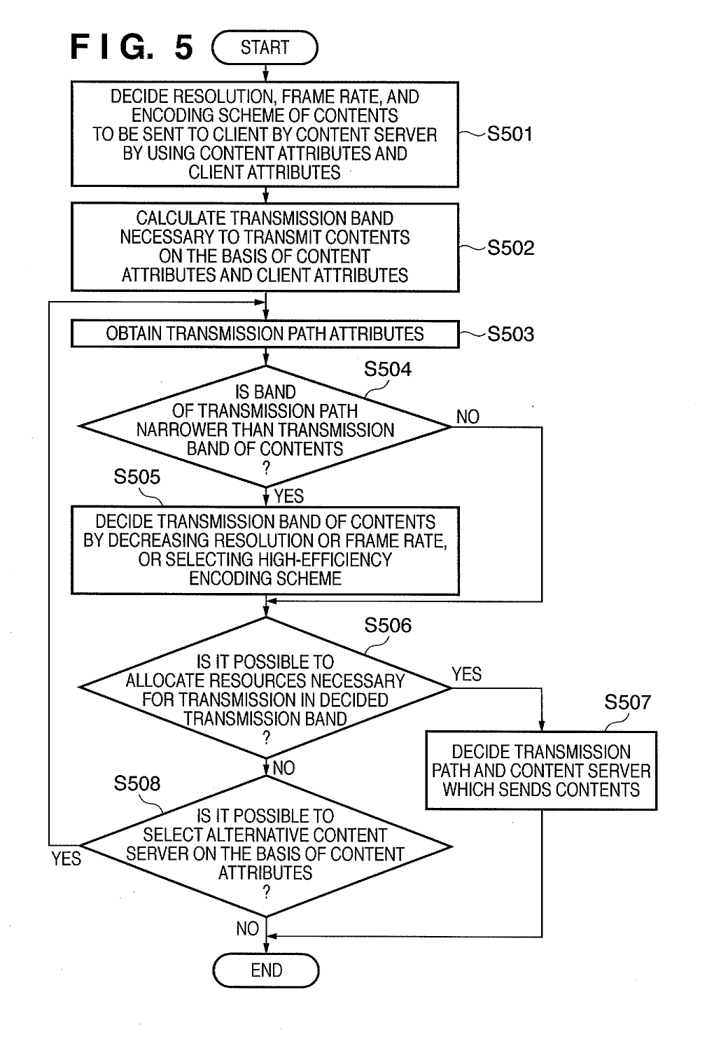

A method of deciding a content server as a transmission source and a transmission path of the contents will now be explained with reference to FIG. 5. FIG. 5 is a flowchart showing a process of deciding, by the management server 103, a content server as a transmission source and a transmission path of the contents.

First, the management server 103 uses the content attributes of the contents requested from a client apparatus and the client attributes of the client apparatus to decide the resolution, the frame rate, the encoding scheme, and the like of the contents to be sent to the client apparatus from the content server (step S501). That is, the management server 103 decides the resolution of the contents to be sent on the basis of image resolution information of the content attributes and requested resolution information of the client attributes. The management server 103 also decides the frame rate of the contents to be sent on the basis of frame rate information of the client attributes. Furthermore, the management server 103 decides an encoding scheme of the contents to be sent on the basis of encoding type information of the content attributes.

Subsequently, the management server 103 calculates the transmission band of the contents to be sent by using band information, of the content attributes, necessary to send the contents, the image resolution information of the content attributes, and requested frame rate information of the client attributes (step S502).

After that, the management server 103 determines a content server storing the contents from content server information storing the content attributes. The management server 103 obtains, from the attribute database 104, the server attributes of the determined content server and the transmission path attributes of a transmission path between the content server and the client apparatus (step S503). Note that when the process returns to step S503 from step S508, the management server 103 obtains the server attributes of the alternative content server determined in step S508 and the transmission path attributes of a transmission path between the alternative content server and the client apparatus.

The management server 103 determines whether a band indicated in band information of the transmission path attributes is narrower than the transmission band calculated in step S503 (step S504).

If the band indicated in the band information of the transmission path attributes is narrower than the transmission band, the management server 103 decides a transmission band of the contents by decreasing the resolution or frame rate of the contents, or selecting a high-efficiency encoding scheme to be executed on the contents (step S505). On the other hand, if the band indicated in the band information of the transmission path attributes is not narrower than the transmission band, the process advances to step S506 without performing the processing in step S505.

The management server 103 determines based on the server attributes and the transmission path attributes whether it is possible to allocate resources necessary to transmit the contents in the transmission band decided in step S503 or S505 (step S506). That is, the management server 103 determines according to communication load information, CPU load information, and memory load information of the server attributes whether it is possible to allocate resources of the content server to be used to transmit the contents in the transmission band. Simultaneously, the management server 103 determines based on the band information of the transmission path attributes whether it is possible to allocate resources of the transmission path to be used to transmit the contents in the transmission band. If the management server 103 determines that it is possible to allocate the resources of the content server and transmission path, the process advances to step S507; otherwise, the process advances to step S508.

In step S507, the management server 103 decides a content server and transmission path for sending the contents. That is, the management server 103 decides to use, for sending the contents, a content server and transmission path corresponding to the server attributes and transmission attributes being currently processed.

In step S508, the management server 103 determines according to the storage content server information of the content attributes whether it is possible to select an alternative content server. If it is possible to select an alternative content server, the management server 103 selects an alternative content server, and executes the processing from step S503 on the content server; otherwise, the process ends.

When the management server 103 decides a transmission path between the client apparatus 102a and the content server with the above operations, the client apparatus 102a leaves the currently connected network and the management server 103 controls connection by the decided transmission path. This control is as described with reference to FIG. 3 in the explanation of the first embodiment.

In the second embodiment, the client apparatus 102a which supplies the contents and the content server are assigned to the network belonging to the same sub-network. According to the second embodiment, it is therefore possible to distribute contents without being influenced by flooding packets and broadcast packets occurring in other networks.

In the second embodiment, it is also possible to distribute and store identical contents in a plurality of content databases 106a to 106d. This allows to select and assign a suitable content server to the client apparatus 102a on the basis of the contents of the attributes upon being requested from the client apparatus 102a.

When, for example, the client apparatuses 102a to 102d are connected within the network distribution system through wireless networks, they are grouped according to SSIDs of wireless access points to which they connect. That is, the client apparatuses 102a to 102d participate in a default network using an SSID in the initial connection. The client apparatuses 102a to 102d then get authentication and authorization of the management server 103 similarly to the above-mentioned wired connection, and obtain an SSID of an access point which connects to a network having the same sub-network as that of the content server. The client apparatuses 102a to 102d leave the default network, connect to the network using the new SSID, and are provided with contents from the content server.

As explained above, according to the second embodiment, it is possible to provide a system in which the management server 103 can control and reserve resources between the client apparatus and the content server by using the attributes (properties) such as the content, transmission path, and content server attributes, when the client apparatus requests the contents.

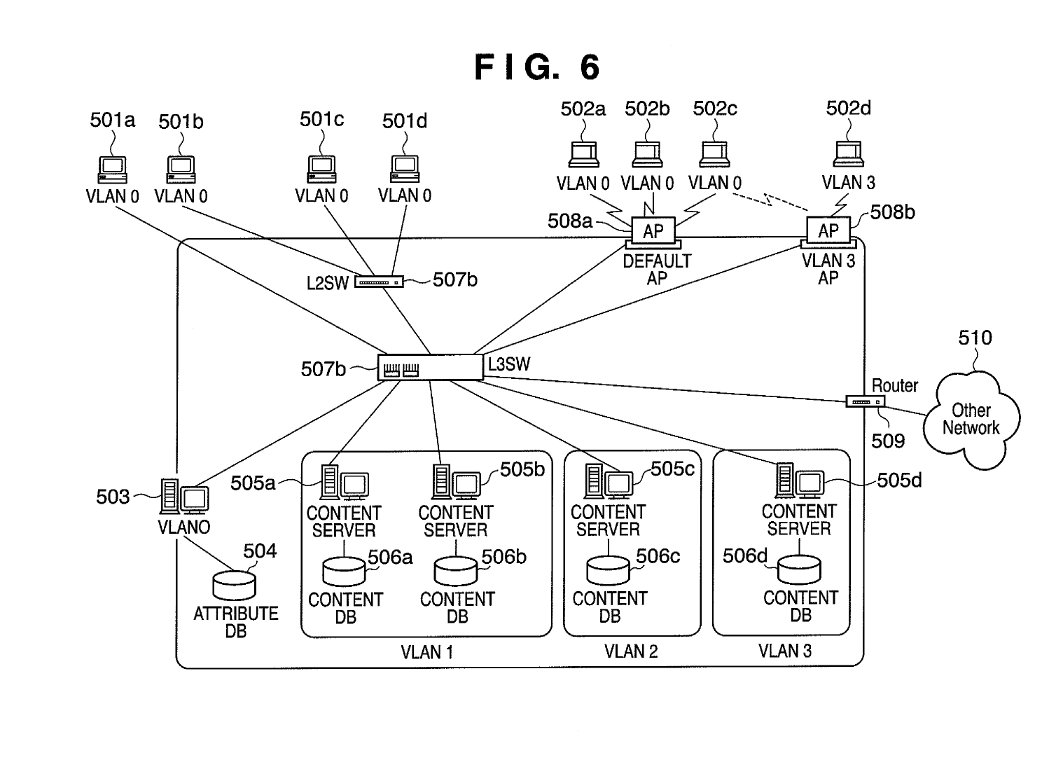

Next, the third embodiment of the present invention will be described. FIG. 6 is a view showing the configuration of a network distribution system according to the third embodiment of the present invention.

Referring to FIG. 6, reference numerals 501a to 501d and 502a to 502d denote client apparatuses. Each of the client apparatuses 501a to 501d and 502a to 502d comprises a computer. Reference numeral 503 denotes a management server; 504, an attribute database; 505a to 505d, content servers; and 506a to 506d, content databases.

Reference numerals 507a and 507b denote network switches capable of establishing a port- or tag-based virtual network; 508a and 508b, wireless access points; 509, a network connection device (router); and 510, an external network.

In the third embodiment, the network switches 507a and 507b conforming to IEEE802.1Q (VLAN (Virtual LAN)) standardized by IEEE are used. Note that IEEE is an abbreviation for “The Institute of Electrical and Electronics Engineers, Inc.”.

In the third embodiment, the management server 503 manages the network switches 507a and 507b, and access to the content servers 505a to 505d from the client apparatuses 501a to 501d and 502a to 502d is controlled. IEEE802.1Q allows to establish a plurality of virtual networks at one port by adding an identifier, which is referred to as VLAN Tag, consisting of four octets in an Ethernet® frame.

In the VLAN Tag format defined by IEEE802.1Q, 0x8100 is appended as VLAN Tag Identifier (TPID) to a conventional MAC header, thus enabling discrimination of VLAN packets from other packets. In this VLAN Tag format, 12 bits are given as an ID in VLAN (VLANID), and it is therefore possible to establish 0 to 4095 virtual networks (sub-networks) in the network as a whole. The operations of a management server, content server, client apparatus, and network switch in response to a content send request from the client apparatus in the network distribution system constituted by the above devices will now be explained step by step.

First, the initial state in the network distribution system will be described. In the initial state, a default VLANID (VLAN0) is assigned to the client apparatuses 501a to 501d and 502a to 502d, and the management server 503 which are connected to the network. On the other hand, the content servers 505a to 505d are assigned VLANIDs (VLAN1, VLAN2, and VLAN3 as shown in FIG. 6) different from VLAN0. Since the client apparatuses 501a to 501d and the content servers 505a to 505d are in different networks, they cannot communicate with each other.

When a given one of the client apparatuses 501a to 501d wants to connect to one of the content servers 505a to 505d, it starts an authentication procedure to the management server 503. The management server 503 specifies one of the content servers 505a to 505d on the basis of client attributes of the given client apparatus as the request source and content attributes of the contents in the manner explained in the above embodiments. The management server 503 changes the VLANID of the given client apparatus to the same VLANID as that of the specified content server.

In the third embodiment, tables indicating the relationships between SSIDs (Service Set Identifier) and VLANIDs are created at the wireless access points 508a and 508b. Since any one of the client apparatuses 502a to 502d which seeks connection accesses the wireless access point 508a, when the VLANID of the client apparatus is changed, the wireless access point 508a makes the client apparatus access a wireless network using a different SSID. When the wireless access point 508a can provide a plurality of SSIDs, it makes the client apparatus access a wireless network using another SSID which establishes a sub-network with a content server within the same wireless access point 508a. Consequently, the VLANID of the client apparatus is the same VLANID as that of the content server, which corresponds to another SSID. The client apparatus and the content server can thus establish a sub-network.

On the other hand, when the wireless access point 508a can only provide one SSID, it makes the client apparatus access a wireless network using an SSID of the other wireless access point 508b. That is, the wireless access point 508a notifies the client apparatus of the SSID for establishing a sub-network with a content server, and the client apparatus accesses to the wireless access point 508b having the notified SSID. As shown in FIG. 6, when the content server 505d distributes contents, the wireless access point 508a makes the client apparatus 502d access the wireless network using the SSID of the VLAN3 access point 508b. With this operation, the client apparatus 502d can be accommodated in the same VLAN3 as that of the content server 505d, and can establish a sub-network with the content server through the wireless access point 508b.

After the above procedure, when connection between the client apparatus and the content server is established and the content server completes the content distribution, the content server issues a notification of the completion of the content distribution to the management server 503. The management server 503 which has received the notification resets the VLANID of the client apparatus to be connected to the default VLAN (VLAN0).

In the third embodiment, it is possible to control network connection by making the client apparatus access the wireless network on the wireless access point side.

In the above-described embodiments, in response to a content distribution request from a client apparatus, a management server reestablishes a network on the basis of client, content, and transmission path attributes, and authorizes connection between the client apparatus and a content server. As explained above, in the above embodiments, while resources of networks and content servers are managed, resources suitable for the contents requested by the client apparatus are assigned. It is therefore possible to provide the client apparatus with a stable content distribution environment.

In the above embodiments, since data is not discarded, it is possible to avoid the quality degradation of data to be distributed.

Means and steps which constitute the above-described embodiments of the present invention can be realized when a program stored in a RAM or ROM of a computer is executed. The present invention includes this program and a computer readable recording medium which records the program.

The present invention may be applied, e.g., to a system, apparatus, method, program or recording medium, and more specifically, to an apparatus comprising a single device.

The present invention is also achieved by supplying a software program for implementing the functions of the above-described embodiments to the system or apparatus directly or from a remote place, and reading out and executing the supplied program codes by the computer of the system or apparatus.

The present invention is therefore implemented by program codes installed in the computer in order to implement functional processes of the present invention by the computer. That is, the present invention includes a computer program for implementing functional processes of the present invention. In this case, the present invention can take any form such as an object code, a program executed by an interpreter, or script data supplied to an OS as long as a program function is attained.

The functions of the above-described embodiments are implemented when the computer executes the readout program. Also, the functions of the above-described embodiments are implemented when an OS or the like running on the computer performs some or all of actual processes on the basis of the instructions of the program.

The functions of the above-described embodiments are implemented when the program read out from the recording medium is written in the memory of a function expansion board inserted into the computer or the memory of a function expansion unit connected to the computer, and the CPU of the function expansion board or function expansion unit performs some or all of actual processes on the basis of the instructions of the program.

The configuration in which the program codes are supplied to the computer through a communication medium such as the Internet also falls within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-092133 filed on Mar. 30, 2007, and Japanese Patent Application No. 2007-291239 filed on Nov. 8, 2007, which are hereby incorporated by reference herein in their entirety.

What is claimed is:

1. A network assignment method comprising the steps of:
receiving a request of a client via a first network;
selecting a second network to be assigned to the client in correspondence with one of a plurality of servers from which the client obtains contents; and
assigning the second network to the client.

2. The method according to claim 1, wherein in the selecting step, a sub-network to be assigned to the client is selected.

3. The method according to claim 1, wherein a plurality of address spaces included in an address space of a network are assigned to the plurality of servers, and in the assigning step, an address included in an address space which has been assigned to the second network is assigned to the client.

4. The method according to claim 3, wherein in the selecting step, the second network is selected in correspondence with a transmission band of each of a plurality of networks.

5. The method according to claim 1, wherein in the selecting step, a virtual network to be assigned to the client is selected.

6. The method according to claim 1, wherein in the assigning step, an identifier, given to communication data, of the second network is assigned to the client.

7. The method according to claim 1, wherein in the assigning step, an access point corresponding to the second network is informed to the client.

8. A network assignment apparatus comprising:
a reception unit adapted to receive a request of a client via a first network;
a selection unit adapted to select a second network to be assigned to the client in correspondence with one of a plurality of servers from which the client obtains contents; and
a assignment unit adapted to assign the second network to the client.

9. The apparatus according to claim 8, wherein said selection unit selects a sub-network to be assigned to the client.

10. The apparatus according to claim 8, wherein a plurality of address spaces included in an address space of a network are assigned to the plurality of servers, and said assignment unit assigns, to the client, an address included in an address space which has been assigned to the second network.

11. The apparatus according to claim 10, wherein said selection unit selects the second network in correspondence with a transmission band of each of a plurality of networks.

12. The apparatus according to claim 8, wherein said selection unit selects a virtual network to be assigned to the client.

13. The apparatus according to claim 8, wherein said assignment unit assigns an identifier, given to communication data, of the second network to the client.

14. The apparatus according to claim 8, wherein said assignment unit informs, to the client, an access point corresponding to the second network.

15. A computer-readable storage medium storing a computer program for assigning a network, the computer program comprising the steps of:
receiving a request of a client via a first network;
selecting a second network to be assigned to the client in correspondence with one of a plurality of servers from which the client obtains contents; and
assigning the second network to the client.

16. The medium according to claim 15, wherein a plurality of address spaces included in an address space of the network are assigned to the plurality of servers, and in the assigning step, an address space which has been assigned to the second network is assigned to the client.

17. The medium according to claim 15, wherein in the assigning step, an identifier, given to communication data, of the second network is assigned to the client.

18. The medium according to claim 15, wherein in the assigning step, an access point corresponding to the second network is assigned to the client.
